(19) United States
(12) Patent Application Publication
(10) Pub. No.: US 2021/0156280 A1
(43) Pub. Date: May 27, 2021

(54) OIL SYSTEM WITH MULTI-TANKS FOR SPLIT CIRCUITS

(71) Applicant: Rolls-Royce Corporation, Indianapolis, IN (US)

(72) Inventors: John Gebhard, Fishers, IN (US); Adam Kempers, Indianapolis, IN (US); Jeremy Gallagher, Carmel, IN (US)

(73) Assignee: Rolls-Royce Corporation, Indianapolis, IN (US)

(21) Appl. No.: 16/694,193

(22) Filed: Nov. 25, 2019

(51) Int. Cl. F01D 25/20; F02C 7/06

(52) U.S. Cl. CPC F01D 25/20; F02C 7/36; F02C 7/06

(57) ABSTRACT

A gas turbine engine for an aircraft may include a shaft fixed to a compressor of the gas turbine engine, at least one of a turboprop and a turbofan, a power gearbox having a power output shaft fixed to the at least one of the turboprop and the turbofan, wherein the power gearbox receives an input rotation from the shaft, an auxiliary gearbox having an auxiliary output shaft powering at least one auxiliary component of the gas turbine engine, a first lubrication system, and a second lubrication system that is separated from the first lubrication system. The first lubrication systems may circulates a first lubricant through the power gearbox, and the second lubrication system may circulate a second lubricant through the auxiliary gearbox.

### TECHNICAL FIELD

This disclosure relates to gearboxes for gas turbine engines, and, in particular to lubrication systems for gearboxes.

### BACKGROUND

Gas turbine engines often have multiple gearboxes that require lubrication. These gas turbines have a variety of drawbacks, limitations, and disadvantages. Accordingly, there is a need for inventive systems, methods, components, and apparatuses described herein.

### BRIEF DESCRIPTION OF THE DRAWINGS

The embodiments may be better understood with reference to the following drawings and description. The components in the figures are not necessarily to scale. Moreover, in the figures, like-referenced numerals designate corresponding parts throughout the different views.

FIG. 1 illustrates a cross-sectional view of an example of a gas turbine engine.

FIG. 2 illustrates a cross-sectional view of an example of a power gearbox for powering at least one of a turboprop and a turbofan.

FIG. 3 illustrates a block diagram of an example of a gas turbine engine having a first lubrication system and a separate second lubrication system.

FIG. 4 illustrates a block diagram of a second example of a gas turbine engine having a first lubrication system and a separate second lubrication system, wherein a failsafe valve is placed between the first lubrication system and the second lubrication system.

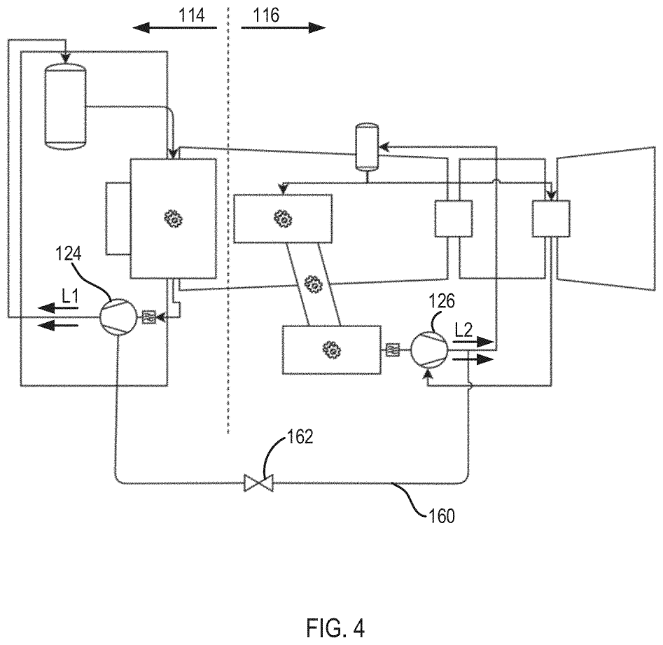

FIG. 5 illustrates a block diagram of an example of a power gearbox having an integrated pump.

FIG. 6 illustrates a block diagram of a third example of a gas turbine engine having a first lubrication system and a separate second lubrication system driven by a common pump.

FIG. 7 illustrates a block diagram of a third example of a gas turbine engine having a first lubrication system and a separate second lubrication system, wherein a common pumping unit circulates lubricant through each of the first lubrication system and the second lubrication system.

### DETAILED DESCRIPTION

By way of an introductory example, a power gearbox may drive at least one of a turboprop and a turbofan in a gas turbine engine. A first lubrication system may be dedicated to the power gearbox. A separate second lubrication system may lubricate and/or cool other components, such as other gearboxes of the gas turbine engine.

One interesting feature of the devices, systems, and methods described below may be that the separate and isolated lubrication systems allow for optimal lubricant selection for critical components of the gas turbine engine, thereby increasing the lifespan of certain components and reducing the maintenance burden.

Another interesting feature of the devices, systems, and methods described below may be that the separate and isolated lubrication systems save valuable space within the confines of the gas turbine engine, thereby providing room for other components.

Another interesting feature of the devices, systems, and methods described below may be that the separate and isolated lubrication systems can save valuable space within the confines of the gas turbine engine, thereby providing room for other components.

Another interesting feature of the devices, systems, and methods described below may be that the separate and isolated lubrication systems reduce the need for filtering and/or increase the lifespan of a lubricant within at least one of the lubrication systems.

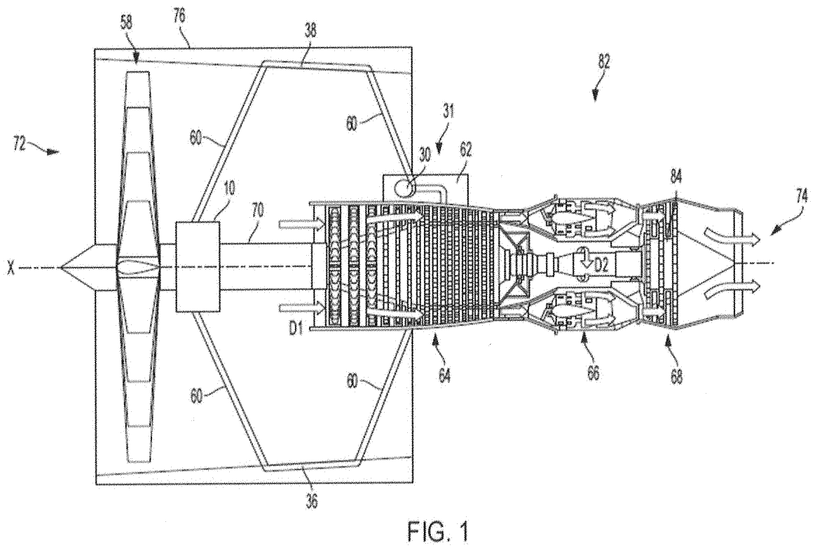

FIG. 1 is a cross-sectional view of a gas turbine engine 82. In some examples, the gas turbine engine 82 may supply power to and/or provide propulsion of an aircraft. Examples of the aircraft may include a helicopter, an airplane, an unmanned space vehicle, a fixed wing vehicle, a variable wing vehicle, a rotary wing vehicle, an unmanned combat aerial vehicle, a tailless aircraft, a hover craft, and any other airborne and/or extraterrestrial (spacecraft) vehicle. Alternatively or in addition, the gas turbine engine 82 may be utilized in a configuration unrelated to an aircraft such as, for example, an industrial application, an energy application, a power plant, a pumping set, a marine application (for example, for naval propulsion), a weapon system, a security system, a perimeter defense or security system.

The gas turbine engine 82 may take a variety of forms in various embodiments. Though depicted as an axial flow engine, in some forms the gas turbine engine 82 may have multiple spools and/or may be a centrifugal or mixed centrifugal/axial flow engine. In some forms, the gas turbine engine 82 may be a turboprop, a turbofan, a geared turbofan, or a turboshaft engine. Furthermore, the gas turbine engine 82 may be an adaptive cycle and/or variable cycle engine. Other variations are also contemplated.

The gas turbine engine 82 may include an intake section 72, a compressor section 64, a combustion section 66, a turbine section 68, and an exhaust section 74. During operation of the gas turbine engine 82, fluid received from the intake section 72, such as air, travels along the direction D1 and may be compressed within the compressor section 64. The compressed fluid may then be mixed with fuel and the mixture may be burned in the combustion section 66. The combustion section 66 may include any suitable fuel injection and combustion mechanisms. The hot, high pressure fluid may then pass through the turbine section 68 to extract energy from the fluid and cause a shaft 70 of a turbine 84 in the turbine section 68 to rotate, which in turn drives the compressor section 64. Discharge fluid may exit the exhaust section 74.

As noted above, the hot, high pressure fluid passes through the turbine section 68 during operation of the gas turbine engine 82. As the fluid flows through the turbine section 68, the fluid passes between adjacent blades of the turbine 84 causing the shaft 70 to rotate. The rotating turbine 84 may turn a shaft 70 in a rotational direction D2, for example. The shaft 70 may rotate around an axis of rotation, which may correspond to a centerline X of the turbine 84 in some examples.

The gas turbine engine 82 may also include a turbofan 58 (or alternatively a turboprop, not shown) located upstream from the compressor section 64. The turbofan 58 may receive fluid from the intake section 72 and direct it downstream. A portion of the fluid passing through the turbofan 58 may enter the compressor section 64 while another portion of the fluid may bypass the compressor section 64. To better direct fluid passing through the turbofan 58, the turbofan may be surrounded by a shroud 76. The shroud 76 may be a component which encircles the turbofan 58. Examples of the shroud 76 may include a duct or a cylindrical shell. The shroud 76 may extend over other portions of the gas turbine engine 82, such as the compressor section 64.

The turbofan 58 may be coupled to the shaft 70 through a power gearbox 10 (e.g., where the power gearbox 10 includes an output shaft fixed to the turbofan 58. The power gearbox 10 may be any component which mechanically transforms rotations D2 of the shaft 70 into rotations of the turbofan 58. Examples of the power gearbox 10 may include a coaxial helical inline gearbox, a bevel helical gearbox, or a planetary gearbox (also known as an epicyclic gear train). The turbofan 58, shroud 76, and power gearbox 10, may be supported by struts 60 coupled to different points of the gas turbine engine 82. For example, as illustrated in FIG. 1, the struts may extend between the power gearbox 10 and the shroud 76, and between the shroud 75 and the compressor section 64. The struts 60 may extend between other portions of the gas turbine engine 82 as well.

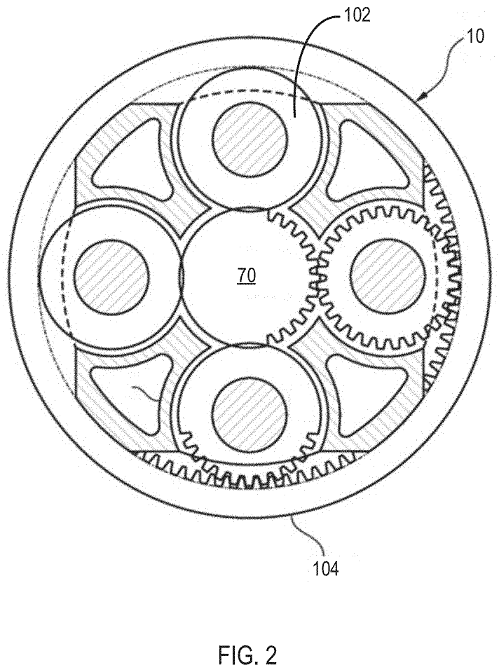

FIG. 2 illustrates a cross-sectional view of the power gearbox 10. The power gearbox 10 may include a plurality of gears 102 which rotate in response to the rotation of the shaft 70. The gears 102 may be any object which is capable of mechanically transferring rotation of one component to another component. For example, the gears 102 may transfer the rotation of the shaft 70 to a rotation of the turbofan 58 depicted in FIG. 1. Non-limiting examples of the gears 102 may include spur gears, helical gears, or herringbone gears forming a planetary gear train. The plurality of gears 102 may rotate a ring gear 104 which encircles the plurality of gears 102. The ring gear 104 may be any component which, through interaction with the plurality of gears, rotates at a reduced rate compared to the rotation of the shaft 70. Examples of the ring gear 104 may include a spur ring gear, a helical ring gear, or a herringbone ring gear. The ring gear 104 may be included in other embodiments of the power gearbox 10. Several examples of non-limiting gearbox embodiments are shown in U.S. application Ser. No. 16/293,790, filed Mar. 6, 2019, and entitled EMBEDDED AUXILIARY OIL SYSTEM FOR GEARBOX PROTECTION, which is hereby incorporated by reference in its entirety.

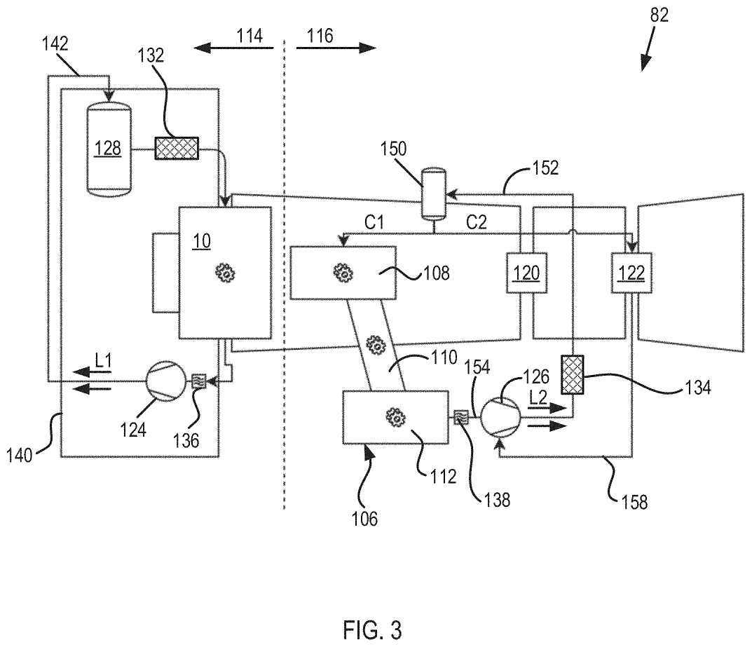

Referring to FIG. 3, the gas turbine engine 82 may additionally include one or more accessory drives, such as the depicted accessory drive 106. The accessory drive 106 may provide power to certain engine components, including auxiliary components such as starters, integrated drive generators (IDG), fuel pumps or other pumps, hydraulic components, lubrication/scavenge components (such as pumps), a de-oiler, generators (for aircraft services and/or engine control), or any other suitable component(s). The accessory drive 106 may include an internal gearbox 108 (or inlet gearbox) that transforms rotation of the shaft 70 (shown in FIG. 1) into rotation of components within a transfer gearbox 110 (e.g., where the transfer gearbox 110 is mechanically coupled to the internal gearbox 108). The internal gearbox 108 may include a bevel gear for direct drive by the shaft 70 (shown in FIG. 1), though an idler shaft or gear may additionally be included, and the transfer gearbox 110 may include any gear structure for transferring associated mechanical energy downstream. In particular, the transfer gearbox 110 may be mechanically coupled to at least one auxiliary gearbox 112, and the transfer gearbox 110 may supply the auxiliary gearbox 112 with mechanical energy for powering auxiliary components. The auxiliary gearbox 112 may be fixed to the shroud 76 (FIG. 1) or another portion of the gas turbine engine housing/casing, but it may alternatively be located in a different location. The auxiliary gearbox 112 may be coupled to one or more auxiliary components.

As shown in FIG. 3, the gas turbine engine 82 may include a first lubrication system 114 devoted to the power gearbox 10 and a second lubrication system 116 devoted to the accessory drive 106 (including its gearboxes). Optionally, the second lubrication system 116 may also provide lubrication to the auxiliary components 120 and/or other turbomachinery components 122 (e.g., high-power electronic components, gears, bearings, and/or any other contact-based mechanical components requiring lubrication or cooling).

The first lubrication system 114 may include a variety of components related to lubrication and cooling. For example, certain included components may include (but are not limited to) a first lubrication pump 124, a first oil tank 128, a first oil cooler 132, and a first oil filter 136. Certain components may be omitted, and/or others may be included.

During operation, the first pump 124 may provide the pressure necessary to circulate a first lubricant L1 through the first lubrication system 114. The first lubricant L1 may include any suitable fluid capable of reducing frictional interaction between mechanical components, such as oil. In the depicted example, the first lubricant L1 may flow from the first pump 124 to the first oil tank 128 (via piping 140) to the first oil tank 128. Examples of the first pump 124 may include fixed displacement pumps or variable displacement pumps, such as a rotary vane pump, a piston pump, or a centrifugal pump. In certain exemplary embodiments, the first pump 124 is driven by the power gearbox 10.

The piping 140 may include a first supply line 142 arranged to direct the first lubricant L1 from the first oil tank 128, through the heat exchanger or first oil cooler 132 (e.g., to transfer heat away from the first lubricant L1), and then to the power gearbox 10. The heated first lubricant L1 may then flow through the first oil filter 136 and then back to the first pump 124. As will be appreciated by those skilled in the art, certain components may be duplicated, omitted, or re-arranged such that the sequence of the loop changes (e.g., the first oil cooler 132 may be located between the power gearbox 10 and the first pump 124, for example).

Similarly, the second lubrication system 116 may include a variety of components related to lubrication and cooling. For example, certain included components may include (but are not limited to) a second lubrication pump 126, a second oil tank 150, a second oil cooler 134, a second supply line 152, a second return line 154, and a second oil filter 138. Certain components may be omitted, and/or others may be included.

During operation, the second pump 126 may provide the pressure necessary to cause a second lubricant L2 to flow through the second lubrication system 116. As discussed in more detail below, the second lubricant L2 may have different characteristics than the first lubricant L1 (or not). In the depicted example, the second lubricant L2 may flow from the second pump 126 to the second oil tank 156 (via piping 158). The piping 158 may include a plurality of parallel lines arranged to direct the second lubricant L2 from the second oil tank 156 to certain gearboxes and/or certain auxiliary component(s) 120. For example, as shown, the second pump 126 directs the second lubricant L2 through a first conduit C1 to the internal gearbox 108 for lubrication and cooling. The second lubricant L2 may flow directly from the internal gearbox 108 to the transfer gearbox 110 (or alternatively tubing may be included therebetween). Similarly, the second lubricant L2 may flow directly from the transfer gearbox 110 to the auxiliary gearbox 112 (or alternatively tubing may be included therebetween). Optionally, a second parallel conduit C2 may be included to direct the second lubricant L2 for lubrication and/or cooling of the auxiliary component 120, but in other embodiments, this second conduit C2 may be in series with the first conduit C1 (or excluded entirely). The second lubricant L2 may then flow through the second oil filter 138 and back to the second pump 126. As will be appreciated by those skilled in the art, certain components may be duplicated, omitted, or re-arranged such that the sequence of the loop changes (e.g., the heat exchanger 134 may be located just before the second pump 126, for example).

A feature of the embodiment of FIG. 3 is that the first lubrication system 114 is wholly separate from the second lubrication system 116 when the gas turbine engine 82 is in a normal operational state. That is, the first lubricant L1 of the first lubrication system 114 does not flow through the piping 158 of the second lubrication system 116, and vice versa, during normal operation. This feature may be advantageous for several reasons. For example, in certain applications, an optimal oil for cooling the power gearbox 10 may be different from an optimal oil for cooling one or more of the components of the accessory drive 106 and/or other turbomachinery components 122. For example, one of the first lubrication system 114 and the second lubrication system 116 may include a respectively high (e.g., at least 10% higher, such as at least 20% higher, than the respective other lubrication system) of at least one of the following: viscosity, water content, calorific content, specific gravity, a different characteristic typically selected with an engine oil, and/or a combination thereof.

Additionally or alternatively, desirable oil conditions may be different in each lubrication system. For example, it may be advantageous for the first lubrication system 114 to operate with the first lubricant L1 at a higher pressure than the second lubricant of the second lubrication system 116. For example, one of the first lubrication system 114 may have an operational oil pressure (e.g., during idle speed) that is at least 10 psi higher than an operational oil pressure in the second lubrication system 116 at the same engine speed at least at one location within the respective circuits, such as at least 20 psi higher, at least 30 psi higher, at least 50 psi higher, etc. (e.g., any reasonable pressure differential based on the engine design). The opposite is also true (e.g., the second lubrication system 116 may have a higher operational pressure than the first oil system 114 at least at one location in the respective circuits). Similarly, it may be advantageous for the first lubricant L1 and the second lubricant L2 to function at different temperatures (e.g., having an average temperature difference of at least about 10 degrees Celsius), different mass and/or volumetric flow rates (e.g., where one flow rate is at least 10% higher than the other).

Separating the first lubricant L1 and the second lubricant L2 also may provide advantages from a filtering perspective. For example, the power gearbox 10, which may include extreme tolerances from a quality perspective, may have a respectively-high cleanliness level relative to certain components cooled and lubricated by the second lubrication system 116. Since the loading on bearings and gears within the power gearbox 10 can be extremely high (making precise and clean lubrication critical), keeping the first lubricant L1 within a dedicated circuit for the power gearbox 10 may isolate the first lubricant L1 from components associated with lower cleanliness. This may increase the lifespan of the first lubricant L1 (and also the power gearbox 10) relative to other embodiments. Additionally, changing the second lubricant L2 may be accomplished without changing the relatively clean first lubricant L1, which may reduce maintenance costs particularly in applications where the first lubrication system 114 requires significantly more lubricant than the second lubrication system 116 (e.g., due to high demands of the power gearbox 10). Further, it is contemplated that the first lubrication system 114 may exclude a filter altogether, which may reduce weight and increase available space for other components.

Advantageously, separating the first lubrication system 114 from the second lubrication system 116 may also allow for a more efficient design that saves space relative to other embodiments. For example, since the first lubrication system 114 and the second lubrication system 116 do not need to interconnect (and may include separate pumps, filters, etc.), each separate lubrication system can be designed to strategically fit in spaces near their respective components, saving valuable space within the housing of the gas turbine engine. Further, certain components that are typical in other embodiments of gas turbine engines may be omitted altogether (saving weight, space, and cost). For example, the present teaching may allow for the omission of a bifurcation panel generally included in existing gas turbine engines, which is commonly nested in a congested location at the aft end of the fan and used to bifurcate oil between different components (such as a power gearbox and auxiliary components).

In some alternative or additional arrangements, the separation systems may be connected via tubing 160 that includes a failsafe valve 162. As shown, the tubing 160 may connect the first pump 124 to the second lubrication system 116 such that, if the second pump 126 fails (or the second lubrication system 116 otherwise fails, such as due to loss of lubrication fluid), the first pump 124 may circulate the first lubrication fluid L1 through the second lubrication system 116 to avoid system failure. While not shown, it is contemplated that the second pump 126 could be used similarly to circulate the second lubrication fluid L2 through the first lubrication system 114 during an emergency situation. The failsafe valve 162 may remain closed in normal operational states, but may open to connect the systems to prevent system failure in rare circumstances.

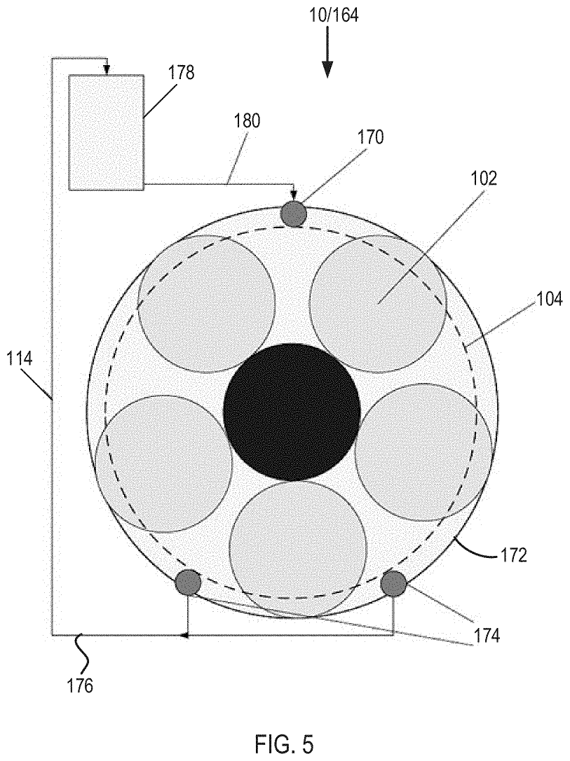

Referring to FIG. 5, in some embodiments, the first lubrication system 114 may include an integrated oil pump 164 within the power gearbox 10 (e.g., while optionally excluding a wholly separate pump dedicated to the first lubrication system 114, such as the first pump 124 shown in FIG. 3). Notably, the power gearbox 10 of FIG. 5 includes five (5) planetary gears 102 rather than four (as in the embodiment of FIG. 2), but the integrated pump described herein may be applicable to both emboldens (in addition to others). Such an integrated oil pump 164 may replace the first pump 124 shown in FIG. 3, for example, thereby saving space, weight, and overall cost of the gas turbine engine. As depicted by FIG. 5, the power gearbox 10 may include the ring gear 104 (shown as a dashed line) that rotates (e.g., upon movement of the planetary gears 102) to drive at least one lubrication supply element 170 fixed to an outer housing 172. The lubrication supply element 170 may include a small oil pump that includes a single (or plurality) of lubrication gerotors, vanes, and/or gears within a relatively small housing, for example. The lubrication supply element 170 provides the first lubrication L1 to the gears and bearings of the power gearbox 10. The power gearbox 10 may also include at least one scavenge elements 174, which also may be driven by rotation of the ring gear 104. Similarly, the scavenge elements 174 may include a relatively small version of an oil pump and include of a singular, or plurality of, gerotors, vanes or gears. These units also have an integral drive-shaft that can motor the oil pump. When the first lubricant is scavenged by the scavenge elements 174, it may then move through a return line 176 to an oil tank 178 and then back to the lubrication supply element 170 through a supply line 180. While not shown, additional elements may be included (e.g., a filter, heat exchanger, an additional pump, etc.). Advantageously, the present embodiment allows the power gearbox 10 to provide the pumping function itself through the integrated oil pump 164, and without a separate pumping device.

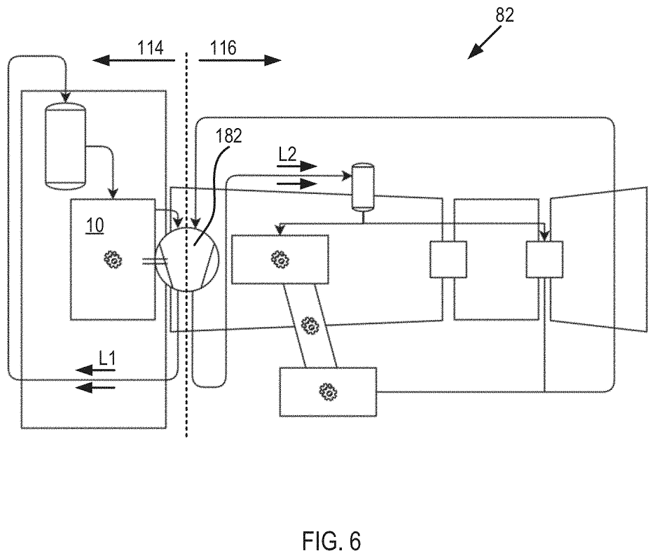

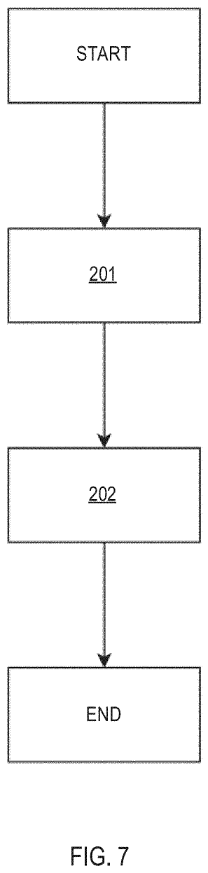

While the embodiment of FIG. 5 shows a single lubrication supply element 170, more than one may be included. Further, while two scavenge elements 174 are shown, more or fewer may be included. FIG. 6 shows another arrangement of the gas turbine engine 82 similar to the embodiment of FIG. 3 above but with a different pump configuration. As shown in FIG. 6, the first lubrication system 114 and the second lubrication system 116 are wholly separate (and the first lubricant L1 and second lubricant L2 do not intermix). However, rather than two separate pumps (e.g., the first pump 124 and the second pump 126 shown in FIG. 3), a single pumping unit 182 provides the energy for circulating lubricant through each of the first lubrication system 114 and the second lubrication system 116. The pumping unit 182 preferably includes two separate pumping chambers such that the first lubricant L1 and the second lubricant L2 o not intermix. Providing a single pumping body may save space, reduce weight, and provide relatively high energy efficiency relative to other embodiments. In particular, it is contemplated that the pumping unit 182 (e.g., all pumping chambers) may be powered by the power gearbox 10. Other power sources may additionally or alternatively be used. For example, any of the pumps discussed herein may be powered by electric motor(s). FIG. 7 shows an exemplary method for operating one or more of the embodiments described above. For example, at a first step 201, the above-described first lubricant L1 may be supplied to the first lubrication system 114. Similarly, at a second step 202, the second lubricant L2 may be supplied to the second lubrication system 116. As discussed above, the first lubrication system 114 may circulate the first lubricant L1 through the power gearbox 10, the second lubrication system L2 may circulate the second lubricant L2 through at least one auxiliary component 120, and the first lubricant L2 may be wholly excluded from the second lubrication system 116.To clarify the use of and to hereby provide notice to the public, the phrases “at least one of <A>, <B>, . . . and <N>” or “at least one of <A>, <B>, . . . <N>, or combinations thereof” or “<A>, <B>, . . . and/or <N>” are defined by the in the broadest sense, superseding any other implied definitions hereinbefore or hereinafter unless expressly asserted herein to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed. Unless otherwise indicated or the context suggests otherwise, as used herein, “a” or “an” means “at least one” or “one or more.”

While various embodiments have been described, it will be apparent to those of ordinary skill in the art that many more embodiments and implementations are possible. Accordingly, the embodiments described herein are examples, not the only possible embodiments and implementations.

The subject-matter of the disclosure may also relate, among others, to the following aspects:

A first aspect relates to a gas turbine engine for an aircraft, the gas turbine engine including: a shaft fixed to a compressor of the gas turbine engine; at least one of a turboprop and a turbofan; a power gearbox having a power output shaft fixed to the at least one of the turboprop and the turbofan, where the power gearbox receives an input rotation from the shaft; an auxiliary gearbox having an auxiliary output shaft powering at least one auxiliary component of the gas turbine engine; a first lubrication system; and a second lubrication system that is separated from the first lubrication system, where the first lubrication systems circulates a first lubricant through the power gearbox, and where the second lubrication system circulates a second lubricant through the auxiliary gearbox.

A second aspect relates to the gas turbine of aspect 1, where the power gearbox includes at least one lubrication supply element that is mechanically coupled to a rotatable ring gear of the power gearbox, where the power gearbox also includes at least one scavenge element mechanically coupled to the ring gear, and where a supply line directs the first lubricant from the scavenge element to the lubrication supply element.

A third aspect relates to the gas turbine of any preceding aspect, further including a pumping unit that is driven by the power gearbox, where the pumping unit causes circulation of the first lubricant through the first lubrication system, and where the pumping unit causes circulation of the second lubricant through the second lubrication system.

A fourth aspect relates to the gas turbine of any of aspects 1 and 2, where the first lubrication system include a first pump, where the second lubrication system includes a second pump, and where the first pump and the second pump are operable independently.

A fifth aspect relates to the gas turbine of aspect 4, where the first pump is driven by the power gearbox.

A sixth aspect relates to the gas turbine of any preceding aspect, where the first lubricant is excluded from the second lubrication system, and where the second lubricant is excluded from the first lubrication system.

A seventh aspect relates to the gas turbine of any preceding aspect, further including a failsafe valve that, when actuated, provide a fluid connection between the first lubrication system and the second lubrication system.

An eighth aspect relates to the gas turbine of any preceding aspect, where the first lubrication system includes a first operation pressure, where the second lubrication system includes a second operation pressure, and where the first operation pressure is greater than the second operation pressure.

A ninth aspect relates to the gas turbine of any preceding aspect, where the first lubrication system lacks a filter.

A tenth aspect relates to the gas turbine of any preceding aspect, where the first lubricant is a different lubricant type than the second lubricant.

An eleventh aspect relates to a gas turbine engine for an aircraft, the gas turbine engine including: a power gearbox having a first input mechanically coupled to a shaft, where the power gearbox includes a first output shaft that drives at least one of a turboprop and a turbofan; a second gearbox having a second input mechanically coupled to the shaft, where a second output shaft of the second gearbox rotates at a different rotational speed than the first output shaft of the power gearbox; a first lubrication system; and a second lubrication system that is separated from the first lubrication system, where the first lubrication systems circulates a first lubricant through the power gearbox, and where the second lubrication system circulates a second lubricant through the second gearbox.

A twelfth aspect relates to the gas turbine of aspect 11, where the power earbox includes at least one lubrication supply element that is mechanically coupled to a rotatable ring gear of the power gearbox, where the power gearbox also includes at least one scavenge element mechanically coupled to the ring gear, and where a supply line directs the first lubricant from the scavenge element to the lubrication supply element.

A thirteenth aspect relates to the gas turbine of aspect 11, further including a pumping unit that is driven by the power gearbox, where the pumping unit causes circulation of the first lubricant through the first lubrication system, and where the pumping unit causes circulation of the second lubricant through the second lubrication system.

A fourteenth aspect relates to the gas turbine of aspect 11, where the first lubrication system include a first pump, where the second lubrication system includes a second pump, and where the first pump and the second pump are operable independently.

A fifteenth aspect relates to the gas turbine of aspect 14, where the first pump is driven by the power gearbox.

A sixteenth aspect relates to the gas turbine of any of aspects 11 to 15, where the first lubricant is excluded from the second lubrication system, and where the second lubricant is excluded from the first lubrication system.

A seventeenth aspect relates to the gas turbine of any of aspects 11 to 16, further including a failsafe valve that, when actuated, provide a fluid connection between the first lubrication system and the second lubrication system.

An eighteenth aspect relates to the gas turbine of any of aspects 11 to 17, where the first lubrication system includes a first operation pressure, where the second lubrication system includes a second operation pressure, and where the first operation pressure is greater than the second operation pressure.

A nineteenth aspect relates to the gas turbine of any of aspects 11 to 19, where the first lubrication system lacks a filter.

A twentieth aspect relates to a method. The method may include the following: supplying a first lubricant to a first lubrication system; and supplying a second lubricant to a second lubrication system, where the first lubrication system circulates the first lubricant through a power gearbox that drives at least one of a turbofan and a turboprop, where the second lubrication system circulates the second lubricant through at least one auxiliary component, and, where the first lubricant is excluded from the second lubrication system.

In addition to the features mentioned in each of the independent aspects enumerated above, some examples may show, alone or in combination, the optional features mentioned in the dependent aspects and/or as disclosed in the description above and shown in the figures.

We claim:

1. A gas turbine engine for an aircraft, the gas turbine engine comprising:
a shaft fixed to a compressor of the gas turbine engine;
at least one of a turboprop and a turbofan;
a power gearbox having a power output shaft fixed to the at least one of the turboprop and the turbofan, wherein the power gearbox receives an input rotation from the shaft;
an auxiliary gearbox having an auxiliary output shaft powering at least one auxiliary component of the gas turbine engine;
a first lubrication system; and
a second lubrication system that is separated from the first lubrication system,
wherein the first lubrication systems circulates a first lubricant through the power gearbox,
wherein the second lubrication system circulates a second lubricant through the auxiliary gearbox.

2. The gas turbine engine of claim 1, wherein the power gearbox includes at least one lubrication supply element that is mechanically coupled to a rotatable ring gear of the power gearbox, wherein the power gearbox also includes at least one scavenge element mechanically coupled to the ring gear, and wherein a supply line directs the first lubricant from the scavenge element to the lubrication supply element.

3. The gas turbine engine of claim 1, further comprising a pumping unit that is driven by the power gearbox, wherein the pumping unit causes circulation of the first lubricant through the first lubrication system, and wherein the pumping unit causes circulation of the second lubricant through the second lubrication system.

4. The gas turbine engine of claim 1, wherein the first lubrication system include a first pump, wherein the second lubrication system includes a second pump, and wherein the first pump and the second pump are operable independently.

5. The gas turbine engine of claim 4, wherein the first pump is driven by the power gearbox.

6. The gas turbine engine of claim 1, wherein the first lubricant is excluded from the second lubrication system, and wherein the second lubricant is excluded from the first lubrication system.

7. The gas turbine engine of claim 1, further comprising a failsafe valve that, when actuated, provide a fluid connection between the first lubrication system and the second lubrication system.

8. The gas turbine engine of claim 1, wherein the first lubrication system includes a first operation pressure, wherein the second lubrication system includes a second operation pressure, and wherein the first operation pressure is greater than the second operation pressure.

9. The gas turbine engine of claim 1, wherein the first lubrication system lacks a filter.

10. The gas turbine engine of claim 1, wherein the first lubricant is a different lubricant type than the second lubricant.

11. A gas turbine engine for an aircraft, the gas turbine engine comprising:
a power gearbox having a first input mechanically coupled to a shaft, wherein the power gearbox includes a first output shaft that drives at least one of a turboprop and a turbofan;
a second gearbox having a second input mechanically coupled to the shaft, wherein a second output shaft of the second gearbox rotates at a different rotational speed than the first output shaft of the power gearbox;
a first lubrication system; and
a second lubrication system that is separated from the first lubrication system,
wherein the first lubrication systems circulates a first lubricant through the power gearbox,
wherein the second lubrication system circulates a second lubricant through the second gearbox.

12. The gas turbine engine of claim 11, wherein the power gearbox includes at least one lubrication supply element that is mechanically coupled to a rotatable ring gear of the power gearbox, wherein the power gearbox also includes at least one scavenge element mechanically coupled to the ring gear, and wherein a supply line directs the first lubricant from the scavenge element to the lubrication supply element.

13. The gas turbine engine of claim 11, further comprising a pumping unit that is driven by the power gearbox, wherein the pumping unit causes circulation of the first lubricant through the first lubrication system, and wherein the pumping unit causes circulation of the second lubricant through the second lubrication system.

14. The gas turbine engine of claim 11, wherein the first lubrication system include a first pump, wherein the second lubrication system includes a second pump, and wherein the first pump and the second pump are operable independently.

15. The gas turbine engine of claim 14, wherein the first pump is driven by the power gearbox.

16. The gas turbine engine of claim 11, wherein the first lubricant is excluded from the second lubrication system, and wherein the second lubricant is excluded from the first lubrication system.

17. The gas turbine engine of claim 11, further comprising a failsafe valve that, when actuated, provide a fluid connection between the first lubrication system and the second lubrication system.

18. The gas turbine engine of claim 11, wherein the first lubrication system includes a first operation pressure, wherein the second lubrication system includes a second operation pressure, and wherein the first operation pressure is greater than the second operation pressure.

19. The gas turbine engine of claim 11, wherein the first lubrication system lacks a filter.

20. A method, comprising:
supplying a first lubricant to a first lubrication system; and
supplying a second lubricant to a second lubrication system,
wherein the first lubrication system circulates the first lubricant through a power gearbox that drives at least one of a turbofan and a turboprop,
wherein the second lubrication system circulates the second lubricant through at least one auxiliary component, and
wherein the first lubricant is excluded from the second lubrication system.
